(19) United States
(12) Patent Application Publication
(10) Pub. No.: US 2011/0019916 A1
(43) Pub. Date: Jan. 27, 2011

(54) Interactive document reading

(76) Inventor: Andrew MacKenzie, Barcelona (ES)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 11/587,406

(22) PCT Filed: Apr. 21, 2005
(86) PCT No.: PCT/US05/51779

§ 371 Date: Oct. 18, 2010

(30) Foreign Application Priority Data
Apr. 23, 2004 (GB) 0409073.4

(51) Int. Cl. G06K 9/00

(52) U.S. Cl. 382/187

(57) ABSTRACT

A system for assisting a user in extracting information from a document set including at least one original document 2 having content comprises: a pen 201 arranged to make pen strokes on a representation of the document 2, a recording system 232 238 242 arranged to record the position of the pen strokes on the representation, and a processor 210, 212, arranged to interpret the pen strokes as identifying selected parts of the content on the document 2 and to produce a reference document relating to the document set, the content of the reference document being dependent on the selected content.

### FIELD OF THE INVENTION

The present invention relates to the extraction of information from documents, and in particular to systems that aid a user to extract information from documents that they are reading.

### BACKGROUND TO THE INVENTION

It has been demonstrated that when a reader reads a document they take in the information in the document more effectively if they read interactively. This includes marking the document as it is read, for example by underlining relevant words or passages or highlighting them in other ways. This also means that the marked document, when referred to again, will be easier to read as the words or passages of interest will be highlighted.

### SUMMARY OF THE INVENTION

The present invention therefore provides a system for assisting a user in extracting information from a document set including at least one original document having content, the system comprising: a pen arranged to be moved over a representation of the original document to define pen strokes, a recording system arranged to record the position of the pen strokes on the representation, and a processor arranged to interpret the pen strokes as identifying selected parts of the content and to produce a reference document relating to the document set, the content of the reference document being dependent on the selected content.

The processor can comprise any suitable processing system, and may comprise a number of processing units arranged to operate together to process the pen strokes. The pen may be arranged to mark the representation of the original document, or it may comprise a simple pointing device such as a stylus. It may comprise part of a more complex system, for example being a light pen.

The content can be in any of a number of forms. For example, it may comprise text, images, drawings, or tables of figures or symbols.

The reference document may be human readable, either directly or by being representable or reproducible in a human readable form. For example the reference document may be an electronic document that can be displayed on screen or printed, or it may be a hard copy document.

The representation may comprise a hard copy of the document, or it may comprise a display of the document, for example on a display screen.

The reference document may include a copy of the document set with additional content, or links to additional content, or an index or summary added to aid re-reading of the document. Alternatively it may comprise a separate document, such as a summary or index of the original document set.

The processor may be arranged to search for other documents using a search strategy determined by the selected content, and to include the other documents in the set. In this case the reference document may simply identify the documents in the set, or it may include an indication of the relevance of at least one of the documents in the set.

The system may be arranged for use by a single user, or it may be arranged to identify a plurality of users, and to produce one reference document for each of the users, using pen strokes made by the respective user. The system may be arranged to identify each user on the basis of the identity of the pen that made the pen strokes, or by other methods such as the use of user names.

The present invention further provides a system for extracting information from a document set including at least one original document having content, the system comprising: a position determining means arranged to receive data defining the position of pen strokes made on a representation of the document by a pen, and processing means arranged to interpret the pen strokes as identifying selected parts of the text on the document and to produce a reference document relating to the document set, the content of the reference document being dependent on the selected content.
26.

The present invention further provides a system for assisting a user in extracting information from an original document having content, the system comprising a manually operable selecting device, operable in conjunction with a representation of the original document to select portions of the content, and a processor arranged to produce a reference document relating to the original document, the content of the reference document being dependent on the selected portions.

The selecting device may be a hand held device. It may also be arranged to be placed in contact with, or close to, the representation in order to select the content. In this case the selecting device may be arranged either to make marks on the representation or simply to move over it. Alternatively the selecting device may be arranged to interact with the representation in some other way, for example by directing a light beam at the representation such that the light beam can be detected. Where the representation is a display, for example on a display screen, the selecting device may be arranged to operate by moving a cursor or other highlighting or selecting device on the screen.

The present invention further provides corresponding methods, and also a data carrier carrying data arranged to control relevant systems to operate as a system according to the invention and to perform the methods of the invention. The data carrier can comprise, for example, a floppy disk, a CDROM, a DVD ROM/RAM (including +RW, −RW), a hard drive, a non-volatile memory, any form of magneto optical disk, a wire, a transmitted signal (which may comprise an internet download, an ftp transfer, or the like), or any other form of computer readable medium.

Preferred embodiments of the present invention will now be described by way of example only with reference to the accompanying drawings.

### BRIEF DESCRIPTION OF THE DRAWINGS

FIG. 1 shows a document having content and a position identifying pattern on it;

FIG. 2 is a schematic view of a system according to a first embodiment of the invention for use with the document of FIG. 1;

FIG. 3 is a diagrammatic view of some of the functional components of the system of FIG. 2;

FIG. 4 is a flow diagram showing a first method of operation of the system of FIG. 2;

FIG. 5 shows the system of FIG. 2 connected to the internet;

FIG. 6 is a flow diagram showing another method of operation of the system of FIG. 2;

FIG. 7 is a flow diagram showing another method of operation of the system of FIG. 2;

FIG. 8 is a schematic view of a system according to a second embodiment of the invention; and

FIG. 9 is a diagrammatic view of some of the functional components of the system of FIG. 8.

### DESCRIPTION OF THE PREFERRED EMBODIMENTS

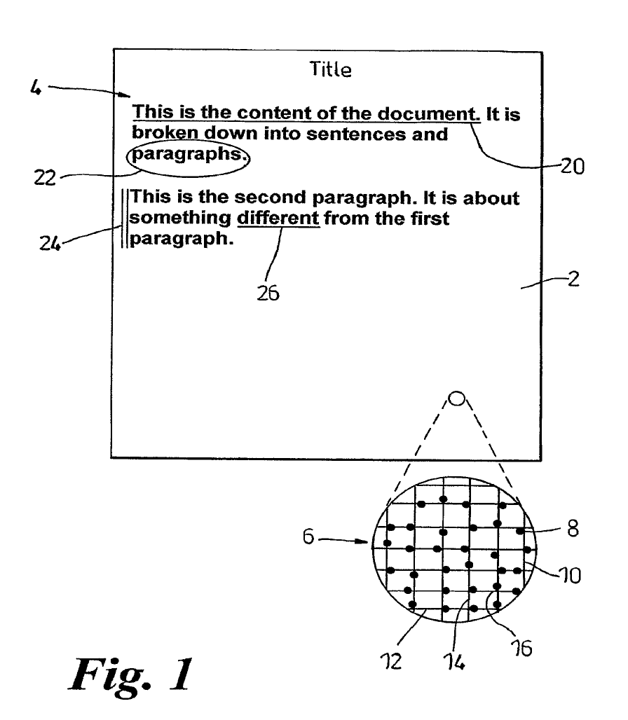

Referring to FIG. 1, systems of the present invention can be arranged for use with documents 2 that have written content 4 and a position identifying pattern 6 thereon. The written content 4 can be in any form, and could, for example, comprise a newspaper or journal article, a novel or short story, an agenda for a meeting, or an index or list. The content is printed onto the document by any suitable process. The position identifying pattern covers the whole of the document 2, although only a small area of it is shown in FIG. 1. The position identifying pattern is made up of a number of graphical elements comprising black ink dots 8 arranged on an imaginary grid 10. The grid 10, which is shown in FIG. 1 for clarity but is not actually marked on the document 2, can be considered as being made up of horizontal and vertical lines 12, 14 defining a number of intersections 16 where they cross. The intersections 16 are of the order of 0.3 mm apart, and the dots 8 are of the order of 100 μm across. One dot 8 is provided at each intersection 16, but offset slightly in one of four possible directions up, down, left or right, from the actual intersection 16. The dot offsets are arranged to vary in a systematic way so that any group of a sufficient number of dots 8, for example any group of 36 dots arranged in a six by six square, will be unique within a very large area of the pattern. This large area is defined as a total imaginary pattern space, and only a small part of the pattern space is taken up by the pattern on the document 2. An example of this type of pattern is described in WO 01/26033.

The position identifying pattern 6 can be detected by a sensing system mounted in a pen, as will be described below, so that the position of marks made on the document 2 by the pen can be detected.

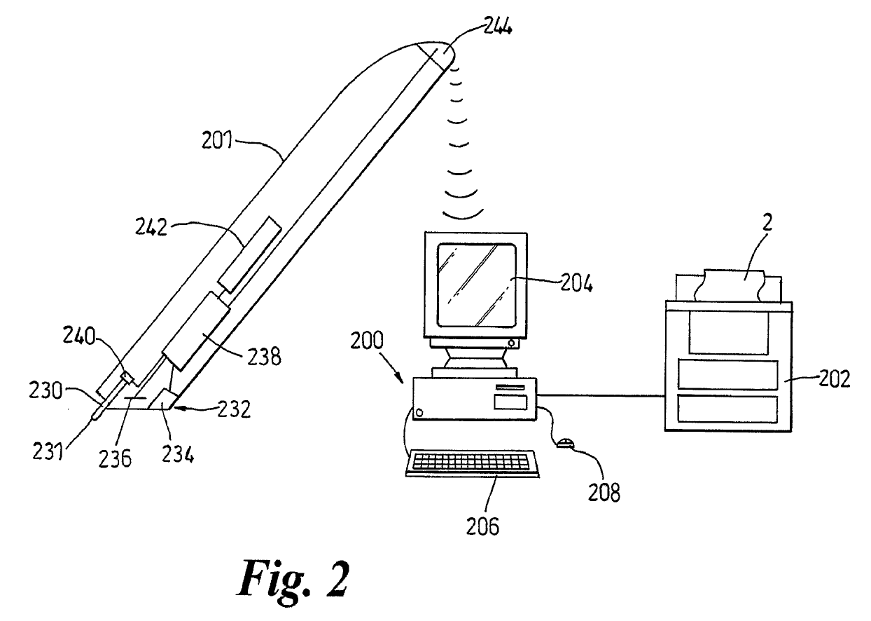

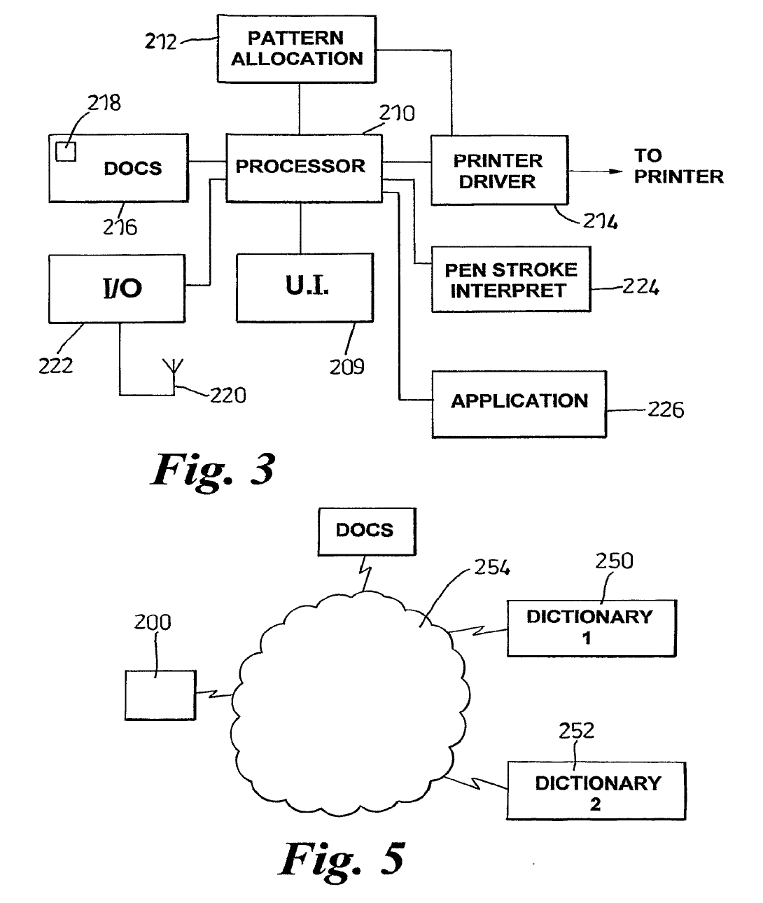

Referring to FIGS. 2 and 3 a system according to an embodiment of the invention, for interactive reading of documents 2 having the position identifying pattern 6 on them, comprises a personal computer (PC) 200, a pen 201, and a printer 202. The PC 200 has a screen 204, a keyboard 206 and a mouse 208 connected to it to provide a user interface 209 as shown generally in FIG. 3. As also shown in FIG. 3, the PC 200 comprises a processor 210 and a pattern allocation module 212 which is a software module stored in memory. The pattern allocation module 212 includes the definition of the total area of pattern space and a record of which parts of that total area have been allocated to specific documents, for example by means of coordinate references. The PC 200 further comprises a printer driver 214, which is a further software module, and a memory 216 having electronic documents 218 stored in it. The electronic documents can have been produced in any suitable manner. For example they may have been generated on the PC using a word processing or drawing package, or they may have been produced by scanning hard copy documents. Alternatively they may have been downloaded to the PC from another source, such as a disc, a local network server, or the internet. The user interface 209 allows a user to interact with the PC 200.

In order to produce the printed documents 2 the processor 210 retrieves an electronic document 218 from the memory 216 and sends it to the printer driver 214. The printer driver 214 allocates a unique document identification code to the document to be printed and requests the required pattern area from the pattern allocation module 212, which communicates the details of the pattern including the positions of all the required dots, back to the printer driver 214. The printer driver 214 then adds the pattern 6 to the electronic document to form an image which includes the pattern 6 and the content 4, converts the document including the pattern 6 to a format suitable for the printer 202, and sends it to the printer 202 which prints the document 2 including the pattern area 6. The exact position of the text on the printed document can change each time the document is printed out. The pattern allocation module 212 therefore stores details of each printed instance of the document including the position on the printed document of all of the content features of the document.

In practice the various components of the system can be spread out over a local network or the internet. For example the pattern allocation module 212 can be provided on a separate internet connected server so that it can be accessed by a number of users.

Referring still to FIG. 2, the pen 201 for reading the pattern 6 comprises a writing nib 230, and a camera 232 made up of an infra red (IR) LED 234 and an IR sensor 236. The camera 232 is arranged to image a circular area adjacent to the tip 231 of the pen nib 230. A processor 238 processes images from the camera 232 taken at a predetermined rapid sample rate. A pressure sensor 240 detects when the nib 230 is in contact with the document 2 and triggers operation of the camera 232. Whenever the pen 201 is being used on a patterned area of the document 2, the processor 238 can therefore determine from the pattern 6 the position on the document 2 over which the pen 201 is being passed. The sequence of positions is saved in the pen's memory 242 as pen stroke data, and can be transmitted to the PC 200 via a radio frequency transmitter 244 in the pen 201. Suitable pens are available from Logitech under the trade mark Logitech Io.

Referring back to FIG. 3, the PC 200 further comprises a radio frequency receiver 220 and an input/output module 222 which processes the signals received by the receiver 220 and inputs them to the processor 210. It also includes a pen stroke interpretation module 224 which is arranged to interpret the pen stroke data from the pen 300 and an application 226 which uses the pen stroke data to perform various functions related to the documents 2.

In use, a user creates one or more documents 218 in electronic form using the application 226, which will be stored in the PC's memory 216. These electronic documents 218 include definitions of written content 4, and may also comprise definitions of other forms of content such as drawings. The documents 218 can be displayed on the screen 204 of the PC and read directly from the screen. However, in this case, a hard copy of the document 2 is printed together with the position identifying pattern 6 as described above. When printing, the printer driver 214 identifies the layout of the printed document, and communicates that layout information to the pattern allocation module 212.

As the user reads the document 2, he can mark it in various ways using the tip of the pen nib 231 to select or highlight various parts of the text. These might be individual words, passages, sentences, paragraphs or sections. In the example shown in FIG. 1, the first sentence of the first paragraph is selected by a single underline 20. The last word of the first paragraph, in this case “paragraphs”, is selected by a ring 22 around the word. The whole of the second paragraph is selected by means of a mark 24 in the margin 26, which in this case is a double line extending vertically down the side of the paragraph. Finally the single word “different” is selected from the second paragraph by a single underline 28.

It will be appreciated that the pen strokes can be made in a number of different ways depending on the nature of the pen. For example the pen could be arranged to act as a highlighter pen so that simply passing it over a word or part of the content would select that word or part.

As the marks 20, 22, 24, 26 are made, the pen 201 identifies the position and shape of the marks in pattern space and records this information as pen stroke data. When the document 2 has been read and marked by the user, the pen 201 is arranged to transmit the pen stroke data defining the marks 20, 22, 24, 26 to the PC. The transmitting of the data can be initiated in a number of ways, for example by marking a specific area of the document 2 that can be recognised by the pen 201 as a ‘send box’ causing the transmission of the data, or by making a mark of a particular shape, that is recognized by the pen as an instruction to transmit the data.

When the PC receives the pen stroke data, the pattern allocation module determines from the position in pattern space of the marks 20, 22, 24, 26, which document they have been made on, in this case the document 2, and the position on that document in which the marks have been made. The application 226 then retrieves the electronic copy 218 of the document 2 from the memory 210, and the definition stored in the pattern allocation module 212 of the printed document. This definition includes data defining all of the text and other content on the document and its position on the document. By combining the content data and the pen stroke data, the application 226 can determine which words, phrases, sentences, paragraphs or passages, or which drawings, diagrams or tables, of the document 2 have been highlighted, and in what manner.

When the highlighted content of the document has been identified, the application 226 can use this information in a number of ways, which can be selected by the user from a suitable menu. One option is for the application 226 to produce a modified electronic version of the document 2 in which the selected content is highlighted. The highlighting can be selected to correspond to the marks made on the original document 2, being made up of lines underlining, circling, or marking in the margin the selected text or drawings. Alternatively the highlighting can be selected to take a different form. For example highlighted text can be converted to a different font, having a different font size, being underlined or in bold, having a different colour, and highlighted drawings or diagrams can be shrunk or simplified. This modified document can then be saved and either viewed on the screen 204 of the PC 200, or printed again for re-reading.

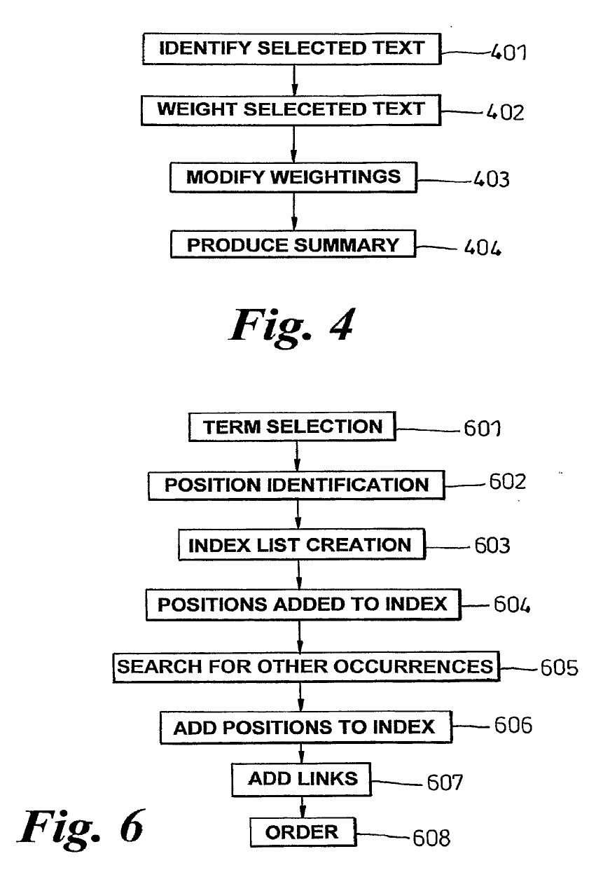

Another option that can be selected is for a summary of the document 2 to be produced, taking into account the selected content. Referring to FIG. 4, in the automatic summarising process the application 226 first identifies text to be summarised at step 401. This can be done on the basis of user inputs to the PC 200 via the user interface, or on the basis of predetermined rules. In this example the summary is of the whole of the document 2. Then at step 402 the processor identifies words and phrases in the document and gives them a weighting based on a number of factors including the number of times they occur. The weighting given to each part of the text is then modified at step 403, as described below, to take into account the selected text. On the basis of the weightings of words and phrases the application identifies sentences that best summarise the whole document, and uses them to produce the summary at step 404.

In the modification to the weightings, any word, phrase or sentence that has been selected is given a higher weighting in the summarising process, so that it is more likely to appear in the summary. Where a whole paragraph is selected, then each sentence and each word in it is given a higher weighting. Where a sentence or phrase is selected, the weighting of both the whole of that sentence or phrase and of each word in it is increased.

Where a single word is selected its weighting is increased by a greater factor than if it just part of a selected phrase or sentence. The weighting accorded to each word, sentence or paragraph is also dependent on the manner in which it has been selected by the pen 201. For example, where a word is circled it is given a higher weighting than if it is only underlined, and a double underlining or a double line in the margin results in a higher weighting than a corresponding single mark. When the summary has been produced, it can either be saved as a separate document, with or without links to the original document or appended to the original document, with or without navigation links back to the original position of the selected text.

The content can include features other than text, and the summary may also include copies of, or simplified or modified versions of, selected drawings, diagrams or tables, or any other selected content. For example, the original document may contain drawings of a large number of items, for example in the form of a catalogue, together with the name of each item and a description of each item. In this case, if the title or a part of the description is selected, then the drawing, either alone or with the title or part of the description, can be incorporated into the summary. Alternatively if the drawing is selected, then part of the description or the title, either with or without the drawing, can be in incorporated into the summary. Another example of an original document including drawings is a technical description that includes graphs, drawings and tables. In this case, where the reference document includes a summary of a section of the description then it can be arranged also to include any graphs, drawings or tables associated with that section.

A further option that can be selected is the production of a modified document in which definitions or translations of the selected terms are added to the document. In this case the PC 200 needs access to suitable dictionaries, either single language dictionaries giving definitions of words in the language in which the document is written, or foreign language dictionaries giving translations from the language of the document 2 into another language. These dictionaries may be available on the PC 200 or a local network, but in this example, as shown in FIG. 5, the PC is internet connected and the dictionaries 250, 252 are accessed over the internet 254. If the user requests same-language definitions for selected words or phrases, then the application accesses the same language dictionary 251 via the internet and obtains suitable definitions. These definitions can be inserted into the electronic document 218, for example in the form of footnotes or in parentheses after the selected terms. This is particularly suitable if the document is to be printed out again for re-reading. Alternatively links to the relevant definitions can be associated with each of the words in the electronic document 218, so that the definitions can be accessed when viewing the document on screen. If the user selects translation of the selected terms, then the foreign language dictionary 252 is accessed, and suitable translations obtained and treated in the same manner as the same language definitions described.

Another option that can be selected is the creation of an index to the selected terms. In this case, referring to FIG. 6, the application 226 identifies at step 601 each of the selected terms, and determines at step 602 the page in the document 2 on which it occurs, as well as the line of the page on which it occurs. It then produces at step 603 an index list of the selected terms, and adds, at step 604, an indication of the page number and line number at which it occurs. As well as the specific occurrence selected by the user, the application 226 is arranged to identify at step 605 all occurrences of the same term throughout the document 218 and identify them all in the index by recording their page and line numbers at page 606. The index list also includes, for each term, a link to the selected term in the position where it was selected in the original document, added at step 607.

The indexed terms are then ordered in the required manner at step 608, for example alphabetically to form the final index. This index can either be appended to the original document 218 or saved as a separate document.

Another option that can be selected is for the selected text to be interpreted as defining a purchase list indicating parts of the document 218 that the user would like to purchase one or more electronic copies of. This is particularly relevant where a user can obtain hard copies of a document free of charge, but can only obtain electronic copies for payment. The selected text can be identified, for example, by highlighting one or more headings which selects the sections or chapters under the headings. Alternatively the selected text can be identified by simply marking in the margin the required text. In either case the ordering can be completed by making payment to the owner of the document and downloading the required electronic copy.

A further option that can be selected is based on the indexing process described above, but is extended to form an information summary covering many documents that the user has read and marked with the pen 201. In this case the summary also acts as an aid to the retrieval of information from all the documents that have been read. As the index is built up it includes not only the page and line references of the selected text, but also the identity of the document in which it was selected. The summarising function described above is also included in this option, so that the index includes, for some of the indexed terms selected by the user, a summary of the passage in which they originally occurred. The extent of the passage that is summarised can also be selected by the user, for example using a line in the margin similar to the line 24 in FIG. 1. Where the user does not define the passage to be summarised, the application 226 selects a default amount of text, in this case the paragraph in which the selected term occurred.

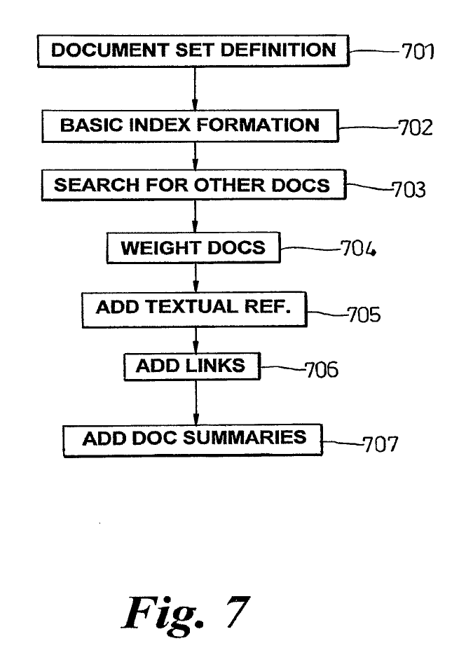

An extension to the multiple document summary described above is also provided whereby the summary is extended to cover not only documents that the user has read, but also documents that they have not read. Referring to FIG. 7, in this case the application 226 has to define at step 701 an identified set of documents that are to be included. In this case the set comprises all of the documents in the memory of the PC that the application can access. However, it can include all documents on a local network, all documents on the internet, or one or more groups of documents from the network or internet. Then at step 702 a basic index is created using the steps of FIG. 5. When the index has been created for the document that has been read, the application carries out a search among all of the documents in the set, to identify any others that contain information relevant to the index term. The first step 703 of the search is simply to identify other documents that contain the index term. A further step 704 is to give a relevance weighting to those documents based on the number of times the term occurs, or the similarity of the context in which it occurs, which can be determined by comparing words around the indexed term. When the further documents have been identified, a textual reference to them, a link to them, and a summary of them are added to the index at steps 705,706 and 707 respectively.

It will be appreciated that in the example just described, the index or summary serves not only as an index but also as a summary of documents read by the user and as a search tool to enable the user to find and read further documents that may be of interest. A further option which is available is for the application 226 to carry out an advanced search function. If the advanced search is selected, the search is carried out not on each selected term individually, but on a combination of a number of selected terms. In this case the documents identified by the search are listed in a search results document and ranked in order of the number of the selected terms that occurs in them. A summary of each of the selected documents, or passages from them, can also be included in the search results document.

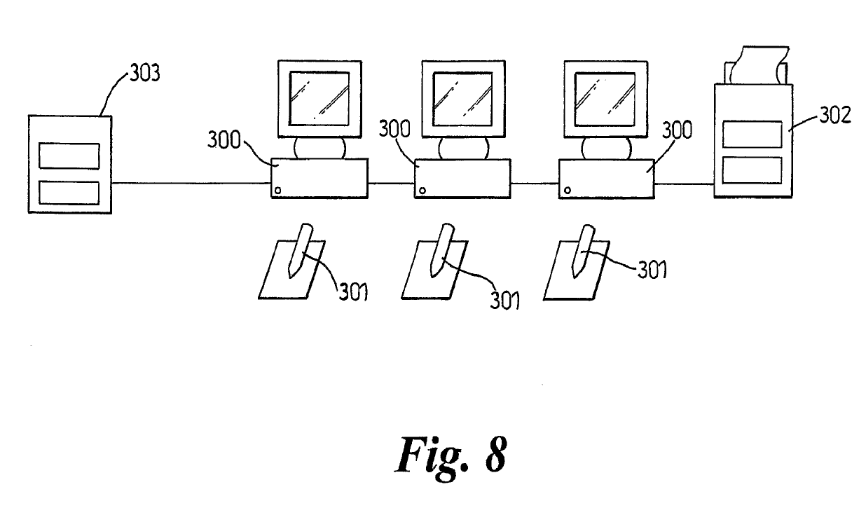

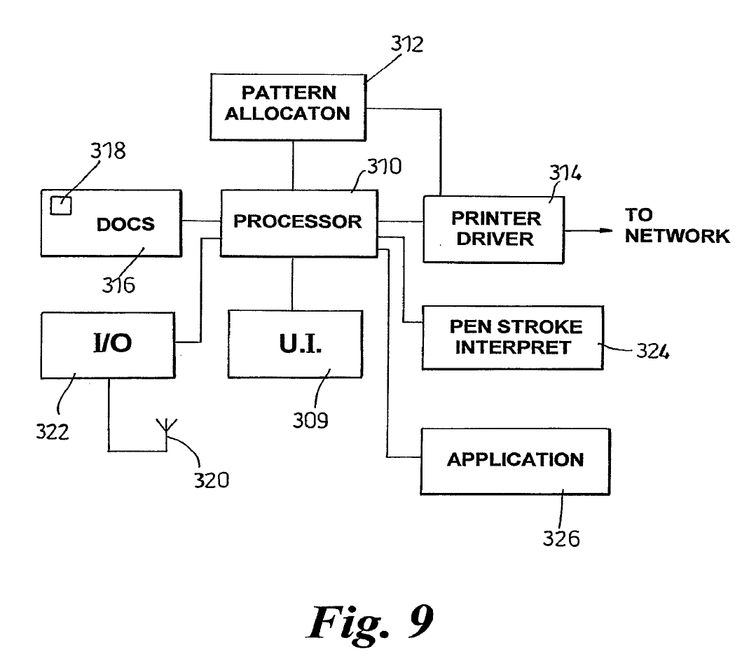

Referring to FIG. 8 in a second embodiment of the invention a number of PCs 300 are networked together on a local area network (LAN) with a network server 303, and a printer 302. A number of pens 301 are provided, each of which has its own unique identity number. Referring to FIG. 9 the server 303 includes all of the functional units of the PC of FIG. 2, which are indicated by the same reference numerals increased by 100. The network is set up for use by a number of users, each of whom has their own user name which is stored on the network server 300. The server 303 is provided with an internet connection. When a user logs onto the network using one of the PCs 300 they input their user ID so that the server can associate all actions that they take with their user ID. A user can access documents 318 stored on the server 303, and other documents stored elsewhere via the internet. Each user can print off hard copies of the documents 318 with position identifying pattern on them and read them, marking them with one of the pens 301.

For each user, as identified by the user ID or by the pen 301 that they use, the server 303 can provide a summary, index, or searching facility as in the first embodiment of the invention described above. However, the server 303 is also arranged to produce similar summaries, indexes and search facilities jointly for groups of two or more of the users, or indeed all of the users. For example, where all of the users are working on a joint project and therefore reading documents relating to that project, a single index is built up based on the pen strokes recorded by all of the users. As described above, this index can include a list of relevant terms, summaries of passages and documents read, and lists and summaries of further documents that have not been read but that might be relevant or of interest.

It will be appreciated that the different users can be identified in a number of different ways for example using writing style analysis or using a biometric identification system linked to the network, such as a fingerprint or iris recognition system.

A further option that is available in the multiple-user system, is for the pen stroke data from all of the users to be combined to form a record, stored on the server 303, of which documents, and which parts of which documents, have been read by which users, and at what times. This data can be combined to produce a summary of the levels of reader interest in each of the documents, indicating for example which are the documents of most interest, which are the documents of least interest, and which groups of readers have shown the most and least interest in any particular document or group of documents. This summary acts as an aid to the users to help them identify the most relevant documents and to extract the most relevant information from those documents.

It will be appreciated that, in the embodiments described above, the position of the pen strokes on the printed copy of the document can be determined in any of a number of ways. For example the printed document can be placed on a detection system that is arranged to track movements of the pen relative to sensors within the detection system, such as infra-red or magnetic sensors.

In a further modification to the embodiments described above, the document is not printed out at all, but is viewed on a screen, and the pen is replaced by a light pen. The light pen includes a photo sensor, and when it is held at a point on the cathode ray tube (CRT) screen, it detects when light is emitted from that point. This information is transmitted to the CRT controller, which controls the position of the CRT electron beam and hence can determine when light will be emitted from each point on the screen.

This enables the CRT controller to determine the position of the pen on the screen. This system therefore enables the user to read the document on screen and make pen strokes on the screen using the light pen. These pen strokes are then interpreted in the same way as the pen strokes in the embodiments described above, using data in the CRT controller that indicates the position on the screen of the content features of the document. In such a system the pen, as that in the previous embodiments, has a tip that can be brought into contact with the representation of the document, and moved over the representation of the document to make the pen strokes. This allows the user to interact closely and directly with the document, in a manner that is familiar to users of conventional pen and paper.

In a further modification, the document is displayed on a tablet PC or other device having a touch sensitive screen. In this case the pen comprises a simple pointer or stylus that can be brought into contact with, and moved across the surface of, the touch sensitive screen, to make the pen strokes. The pen stroke data is then captured by the touch sensitive screen and processed as in the previous embodiments.

1. A system for assisting a user in extracting information from a document set including at least one original document having content, the system comprising: a pen arranged to be moved over a representation of the original document to define pen strokes, a recording system arranged to record the position of the pen strokes on the representation, and a processor arranged to interpret the pen strokes as identifying selected parts of the content and to produce a reference document relating to the document set, the content of the reference document being dependent on the selected content.

2. A system according to claim 1 wherein the reference document includes a copy of the document set with additional content added to aid re-reading of the document.

3. A system according to claim 1 or claim 2 wherein the reference document includes a copy of the document set with a link to additional content to aid re-reading of the document.

4. A system according to claim 2 or claim 3 wherein the additional content is arranged to highlight at least part of the selected content.

5. A system according to any of claims 2 to 4 wherein the content comprises text and the additional content includes a translation of at least one part of the selected text.

6. A system according to any of claims 2 to 4 wherein the content comprises text and the additional content includes a definition of at least one part of the selected text.

7. A system according to any foregoing claim wherein the reference document includes an index to the selected content.

8. A system according to claim 7 wherein the index identifies the position of the selected content in the document set.

9. A system according to claim 8 wherein the content comprises text and the selected text is used to form indexed terms in the index.

10. A system according to any of claims 7 to 9 wherein the index includes a link to the original position in the document set of at least a part of the selected content.

11. A system according to any foregoing claim wherein the reference document includes a summary of at least a part of the document set.

12. A system according to claim 10 wherein the processor is arranged to prepare the summary taking into account the selected text.

13. A system according to claim 11 wherein the processor is arranged to interpret the pen strokes as selecting the text in a plurality of different ways, and, when preparing the summary, to take into account the way in which the selected text is selected.

14. A system according to claim 12 or claim 13 wherein the processor is arranged to prepare the summary on the basis of a weighting which it defines for different parts in the original document, and the weighting of the selected text is modified in response to its having been selected.

15. A system according to any foregoing claim wherein the set includes a plurality of original documents and the reference document refers to each of the original documents.

16. A system according to any foregoing claim wherein the processor is arranged to search for other documents using a search strategy determined by the selected content, and to include the other documents in the set.

17. A system according to claim 16 wherein the reference document identifies the documents in the set.

18. A system according to claim 16 or claim 17 wherein the reference document includes an indication of the relevance of at least one of the documents in the set.

19. A system according to claim 18 wherein the processor is arranged to determine the relevance on the basis of the selected content.

20. A system according to claim 13 or claim 14 wherein the reference document includes at least one link to each document in the set.

21. A system according to any foregoing claim arranged to identify a plurality of users, and to produce one reference document for each of the users, using pen strokes made by the respective user.

22. A system according to claim 21 arranged to identify each user on the basis of the identity of the pen that made the pen strokes.

23. A system according to any foregoing claim wherein the reference document is an electronic document.

24. A system according to any of claims 1 to 22 wherein the original document is an electronic document.

25. A system for assisting a user in the extraction of information from a document set including at least one original document having content, the system comprising: a recording system arranged to receive data defining the position of pen stokes made on a representation of the document by a pen, and a processor arranged to interpret the pen strokes as identifying selected parts of the content and to produce a reference document relating to the document set, the content of the reference document being dependent on the selected content.

26. A system for assisting a user in extracting information from a document set including at least one original document having content, the system comprising: a pen arranged to be moved over a representation of the original document to define pen strokes, a position determining means arranged to determine the position of the pen strokes on the representation, and processing means arranged to interpret the pen strokes as identifying selected parts of the content and to produce a reference document relating to the document set, the content of the reference document being dependent on the selected content.

27. A system for assisting a user in extracting information from an original document having content, the system comprising a manually operable selecting device, operable in conjunction with a representation of the original document to select portions of the content, and a processor arranged to produce a reference document relating to the original document, the content of the reference document being dependent on the selected portions.

28. A system according to claim 27 wherein the content includes text, and the selecting device is arranged to select, from the text, at least one of a word, a phrase, a sentence and a paragraph.

29. A method of extracting information from a document set including at least one original document having content, the method comprising: making pen strokes with a pen on a representation of the document, recording the position of the pen strokes on the representation, interpreting the pen strokes using a processing means as identifying selected parts of the content on the document and producing using the processing means a reference document relating to the document set, the content of the reference document being dependent on the selected content.

30. A data carrier carrying data arranged to control a computer system to operate as a system according to any of claims 1 to 28 or to carry out the method of claim 29.
